(19) United States
(12) Patent Application Publication
(10) Pub. No.: US 2008/0030121 A1
(43) Pub. Date: Feb. 7, 2008

(54) Flat Type Discharge Tube

(76) Inventors: Junichi Iwama, Gifu-ken (JP); Takehito Nakashima, Gifu-ken (JP)

Correspondence Address: REED SMITH LLP, 3110 FAIRVIEW PARK DRIVE, SUITE 1400, FALLS CHURCH, VA, 22042, US

(21) Appl. No.: 10/571,058

(22) PCT Filed: Sep. 2, 2004
(86) PCT No.: PCT/JP04/12732

§ 371 Date: May 23, 2007

(30) Foreign Application Priority Data
Sep. 9, 2003 (JP) 2003-316120

(51) Int. Cl. H01J 63/04

(52) U.S. Cl. 313/485

(57) ABSTRACT

In a flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, and electrodes in the form of a thin membrane respectively deposited on the outer surfaces of the dielectric plates, wherein the electrodes are applied with a specified voltage to cause discharge in inert gas filled in spaces among the dielectric ribs within the sealed space thereby to produce visible light on a light emitting surface formed on at least one of the electrodes, the first dielectric plate is formed at its outer peripheral edge with an outer peripheral frame having a support surface of the same height as the dielectric ribs, the second dielectric plate being bonded by an adhesive coated in a recess formed along one side of the support surface and secured tightly at its bottom surface in contact with the top surface of the respective dielectric ribs.

### FIELD OF THE INVENTION

The present invention relates to a flat-type discharge lamp used for a backlight of a liquid crystal display, a fluorescent lamp, etc.

### DISCUSSION OF THE PRIOR ART

A flat-type discharge lamp of this kind is disclosed in Japanese Patent Application No. 2003-172979. As shown in FIGS. 1(a)˜1(b), the flat-type discharge lamp is composed of a first dielectric plate 52b formed with a plurality of equally spaced dielectric ribs 70 at the same height defined by a specified discharge distance, a second dielectric plate 52a assembled in parallel with the first dielectric plate 52b, and electrodes 55, 56 in the form of a thin membrane respectively deposited on the outer surfaces of the dielectric plates. In the flat-type discharge lamp, inert gas such as xenon (Xe) is filled in sealed spaces between the dielectric plates, and the electrodes are applied with a specified AC voltage to discharge the inert gas in the sealed spaces thereby to produce visible light on a light-emitting surface formed on at least one of the electrodes.

In the flat-type discharge lamp, the first dielectric plate 52b and second dielectric plate 25a each are in the form of a base plate of glass. The electrode 56 deposited on the outer surface of first dielectric plate 52 is in the form of an opaque electrode formed by metallic membrane of silver, aluminum, etc., while the electrode 55 deposited on the outer surface of second dielectric plate is in the form of a transparent electrode formed as a light-emitting surface S by metallic membrane of indium tin-oxide (ITO. In addition, a fluorescent membrane 57 is deposited on the inner surface of first dielectric plate 52b.

In the manufacturing process of the flat-type discharge lamp, the dielectric ribs 70 and outer peripheral frame 72 of first dielectric plate 52b is formed by micro-blast machining capable of minute machining of fragile material such as glass, silicon, ceramic or the like. To form the dielectric ribs 70 and outer peripheral frame 72 at the same height in the micro-blast machining, particles of about 3˜100 μm are blasted under high pressure on the surface of the base plate of glass. The second dielectric plate 52a is heated for

a predetermined time at a predetermined temperature (about 550° C.) in a furnace in a condition where it has been bonded at its bottom surface to a glass adhesive 71 (glass of low melting point) coated on the outer peripheral frame 72 and dielectric ribs 70. With such a burning process, the second dielectric plate 52a is tightly secured in parallel on the surface of first dielectric plate to form a plurality of sealed spaces subdivided by the dielectric ribs 70. After the burning process, the transparent electrode 55 forming the light-emitting surface S is deposited on the surface of second inductive plate 52, and the opaque electrode 56 is deposited on the bottom surface of first dielectric plate. The fluorescent membrane is deposited on each inner surface of the first dielectric plate 52b among the dielectric ribs 70.

As shown in FIG. 1(a), the outer peripheral frame 72 is provided with a suction port 60 for connection to a vacuum pump (not shown). The air in all the sealed spaces is exhausted by operation of the vacuum pump through the suction port 60. Thereafter, a required amount of inert gas such as xenon (Xe) is supplied into all the sealed spaces through the suction port 60. Finally, leading wires 59a, 59b are connected at their one ends to the transparent electrode 55 and opaque lectrode 56 by means of conductive adhesive 58a, 58b and connected at their other ends to a source of alternating current.

When the air in the sealed spaces among the dielectric plates 25b, 25a is exhausted in the manufacturing processes described above, as shown in FIG. 2(b) fixed ends S1, S2, S2′, S5 of the second dielectric plate 52a to the dielectric ribs 70 and outer peripheral frame 72 are applied with bending stress caused by load from the exterior under atmospheric pressure. To uniform the bending stress applied to the fixed ends of the second dielectric plate and to eliminate a local bending force applied to the second dielectric plate 52a, a space A between the inner wall surface of the outer peripheral frame 72 and the side wall surface of dielectric rib 70 opposed thereto is made equal to a space B between the side wall surfaces of the respective dielectric ribs 70. In addition, the glass adhesive 71 is coated on the surface of each dielectric rib 70 to eliminate the occurrence of strain or crack at the fixed ends of the second dielectric plate 52a.

It is, however, difficult to uniform thickness of the glass adhesive coated on the surface of each inductive rib 70 because of fluidity of the adhesive. If the thickness of glass adhesive coated on the surface of respective dielectric ribs 70 becomes unevenness, the parallelism of the first and second dielectric plates 52, 52a may not be ensured after the burning process. As a result, uniform light emitting may not be effected due to unevenness of the discharge distance among the sealed spaces. If the glass adhesive adhered to the bottom surface of second dielectric plate 52a spread and protruded from the both sides of respective dielectric ribs 70, uniform light emitting would not be effected when the flat-type discharge lamp was put on, and the glass adhesive protruded from the both sides of respective dielectric ribs 70 appears in black when the flat-type discharge lamp was put off. This spoils the appearance of discharge lamp.

### SUMMARY OF THE INVENTION

A primary object of the present invention is to solve the problem caused by coating of the glass adhesive in the manufacturing process thereby to provide a flat-type discharge lamp capable of effecting uniform light emitting in a lighted condition and being attractive in a put off condition.

According to the present invention, the object is attained by providing a flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, and electrodes in the form of a thin membrane respectively deposited on the outer surfaces of the dielectric plates, wherein the electrodes are applied with a specified voltage to cause discharge in inert gas filled in spaces among the dielectric ribs within the sealed space thereby to produce visible light on a light emitting surface formed on at least one of the electrodes, wherein the first dielectric plate is formed at its outer periphery with an outer peripheral frame having a support surface of the same height as the dielectric ribs, the second dielectric plate is bonded by an adhesive coated in a recess formed along one side of the support surface and secured tightly at its bottom surface in contact with the top surface of the respective dielectric ribs, and wherein a space between the inner wall of the outer peripheral frame and the dielectric rib opposed thereto is determined narrower in width than each space among the other dielectric ribs.

Other characteristics and advantages of the present invention will be readily understood from the following description of preferred embodiments with reference to the accompanying drawings.

### BREIF DESCRIPTION OF THE DRAWINGS

FIG. 1(a) is a perspective view of a conventional flat-type discharge lamp;

FIG. 1(b) is a cross-sectional view of the flat-type discharge lamp shown in FIG. 1(a):

FIG. 2(a) is a partly enlarged view of FIG. 1(b);

FIG. 2(b) is a partly enlarged view illustrating a local bending stress acting on a second dielectric plate adhered to a first dielectric plate during vacuum exhaust in a manufacturing process of the flat-type discharge lamp shown in FIG. 1(a);

FIG. 3(a) is a perspective view of a flat-type discharge lamp according to the present invention;

FIG. 3(b) is a cross-sectional view of the flat-type discharge lamp shown in FIG. 3(a);

FIG. 4(a) is a partly enlarged view of FIG. 3(b);

FIG. 4(b) is a partly enlarged view illustrating a local bending stress acting on a second dielectric plate adhered to a first dielectric plate during vacuum exhaust in a manufacturing process of the flat-type discharge lamp shown in FIG. 3(b);

FIGS. 5(a) and 5(b) each are a sectional view illustrating another embodiment of the present invention;

FIGS. 6(a) and 6(b) each are a plan view showing an arrangement of dielectric ribs in the flat-type discharge lamp of the present invention;

FIGS. 7(a)˜7(f) each are a partially sectional view showing another bonding method of the second dielectric plate to the first dielectric plate in the flat-type discharge lamp according to the present invention;

FIG. 8(a) is a perspective view of a still another embodiment of a flat-type discharge lamp according to the present invention; and

FIG. 8(b) is a partly enlarge view of FIG. 8(a).

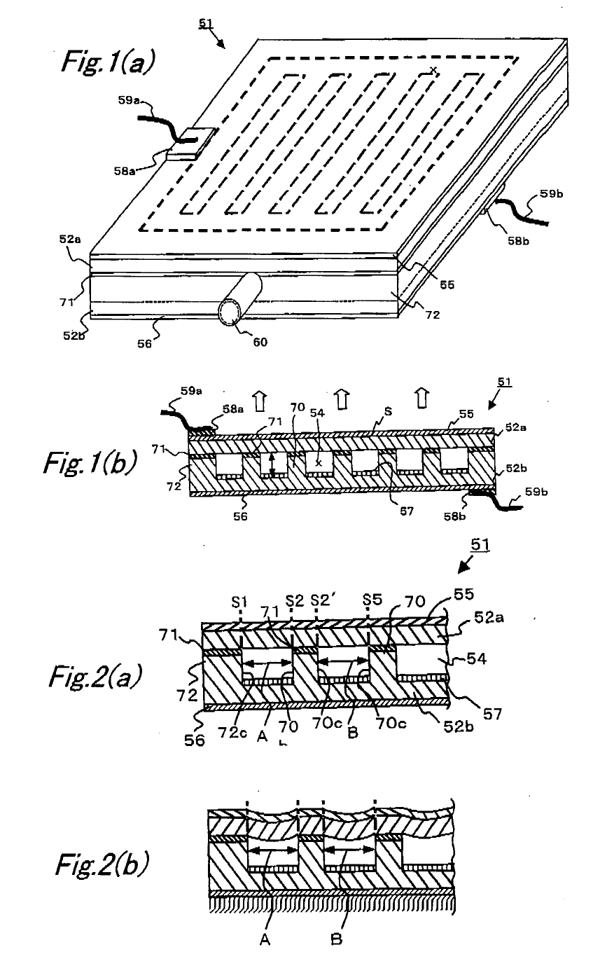

### DESCRIPTION OF PREFERRED EMBODIMENTS

Hereinafter, a preferred embodiment of a flat-type discharge lamp according to the present invention will be described with reference to the drawings. As shown in FIGS. (a) and (b), the flat-type discharge lamp in this embodiment comprises a pair of base plates of glass 2 and 3 which are vertically spaced in height R corresponding with a specified discharge distance d and connected to each other in an air-tight manner to form a sealed space therein. The base plate of glass 2 positioned at the lower side is in the form of a first dielectric plate which is formed at its outer periphery with a quadrilateral outer peripheral frame 4 and at its inner surface with a plurality of equally spaced dielectric ribs 5 at the same height R defined by the specified discharge distance d. The outer peripheral frame 4 formed on the first dielectric plate 2 has a support surface 4b of the same height as the dielectric ribs 5. The bottom surface of a recess 4a formed along the outer periphery of support surface 4b is defined less in height K than the discharge distance d. Accordingly, the height R of dielectric ribs 5 and the height J of support surface are defined equal to the discharge distance d, and the height K of the bottom surface of recess 4a positioned outside of the support surface is defined lower than the height R of dielectric ribs 5. The dielectric ribs 5 are extended in parallel on the inner surface of the first dielectric plate 2 in a fore-and-aft direction and spaced from the inner wall of the outer peripheral frame 4 at their front and rear ends. With such arrangement of the dielectric ribs 5, a plurality of discharge spaces are formed among the dielectric ribs 5 in open communicated with each other at their front and rear ends. The outer peripheral frame 4 and dielectric ribs 5 are formed by micro-blasting of the base plate of glass in a condition where the surface of the base plate was covered with masking at portions corresponding with the outer peripheral frame 4 and dielectric ribs 5. In addition, a fluorescent membrane is deposited on the inner surface of first dielectric plate positioned between the dielectric ribs 5.

In this embodiment, it is to be noted that as shown in FIG. 4(b), a space A between the inner wall 4c of outer peripheral frame 4 and a side surface 5b of the dielectric rib 5 opposed thereto is defined narrower in width than each space B between side surfaces 5c of the other dielectric ribs 5. The base plate 3 of glass is overlapped with a support surface 4b of the outer peripheral frame 4 of the base plate 4 and bonded in position by a glass adhesive (glass of low melting point) coated in a recess 4a formed in the outer peripheral frame 4. In such a condition, the base plate 3 is brought into a furnace and burned at a specified temperature in the furnace. Thus, the base plate 3 of the second dielectric plate is integrally secured with the base plate of first dielectric plate 2 only at its outer peripheral edge through the glass adhesive in a condition where it was tightly retained in contact with the top surface of the respective dielectric ribs 7.

The second dielectric plate 3 is provided thereon with a transparent electrode 8 in the form of a membrane formed by deposit of indium tinoxide (ITO) as a light emitting surface. On the other hand, the first dielectric plate 2 is provided at its bottom with an opaque electrode 9 in the form of a membrane formed by deposit of metal such as silver, aluminum or the like. In addition, leading wires 11a, 11b are connected at their one ends to the outer surface of transparent electrode 8 and to the outer surface of opaque electrode 9, respectively. The leading wires 11a, 11b are at their other ends to a source of alternating current (not show).

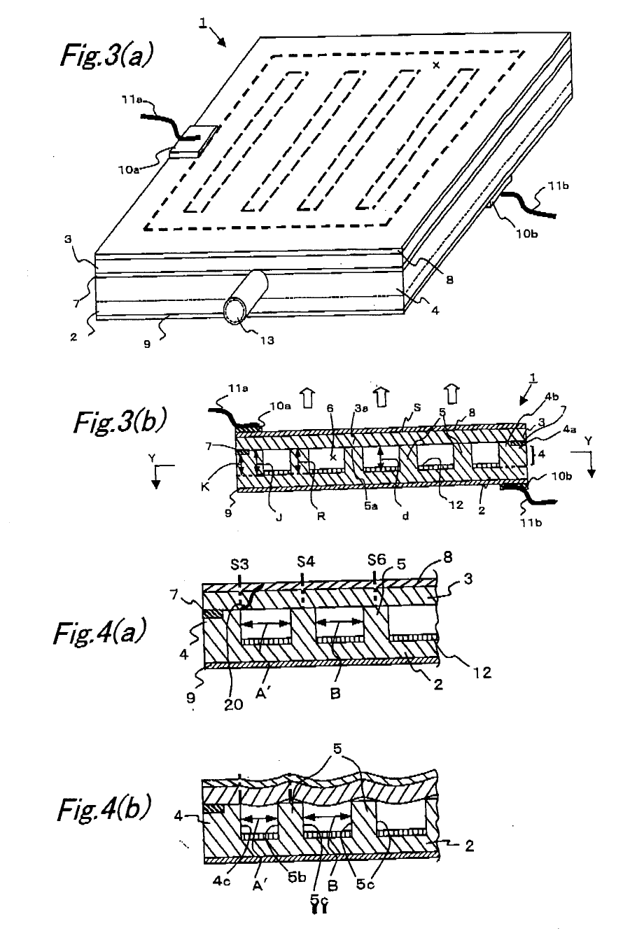

As shown in FIG. 3(a), the outer peripheral frame 4 of first dielectric plate 2 is provided with a suction port 13 for connection with a vacuum pump (not shown). The air in all the sealed spaces subdivided by the dielectric ribs 5 is exhausted by operation of the vacuum pump through the suction port 13. After exhaustion of the air, a required amount of inert gas such as xenon is filled in all the sealed spaces through the suction port 13.

When the flat-type discharge lamp as described above is turned on, the transparent electrode 8 and opaque electrode 9 are applied with an alternating current voltage through the leading wires 11a, 11b to cause barrier discharge between the dielectric plates 2 and 3. Thus, xenon atom excited by the barrier discharge causes ultraviolet rays, and the fluorescent membrane is applied with the ultraviolet rays to produce visible light on the light emitting surface S in the form of the transparent electrode.

As is understood from the foregoing facts, the flat-type discharge lamp according to the present invention is characterized in that the first dielectric plate 2 is formed at its outer periphery with the outer peripheral frame 4 having the support surface 4b of the same height as the dielectric ribs 5 and that the second dielectric plate 3 is bonded by the adhesive 7 coated in the recess 4a formed along one side of the support surface 4b and fixed tightly at its bottom surface in contact with the top surface of the respective dielectric ribs 5.

In the manufacturing process of the flat-type discharge lamp, the glass adhesive is coated only in the recess 4a of the outer peripheral frame 4 formed on the outer periphery of first dielectric plate 2 for adhesion of the dielectric plates 2 and 3 without coating the glass adhesive on the top surfaces of dielectric ribs 5. This is useful to simplify the coating work of the glass adhesive to the first dielectric plate 2 and to eliminate protrusion of the glass adhesive from the both sides of the respective dielectric ribs 5.

In the case that the space between the inner wall of the outer peripheral frame and the side surface of dielectric rib 5 opposed thereto is defined narrower in width than each space between side surfaces of the other dielectric ribs 5, any local bending stress does not occur at portions of the second dielectric plate 3 in contact with the top surfaces of dielectric ribs 5 in the process for exhausting the air from the sealed spaces among the dielectric ribs 5. This is useful to lighten the concentration of bending stress at the connected portion of second dielectric plate to the outer peripheral frame 4 of first dielectric plate 1 and to prevent crack of the second dielectric plate 3.

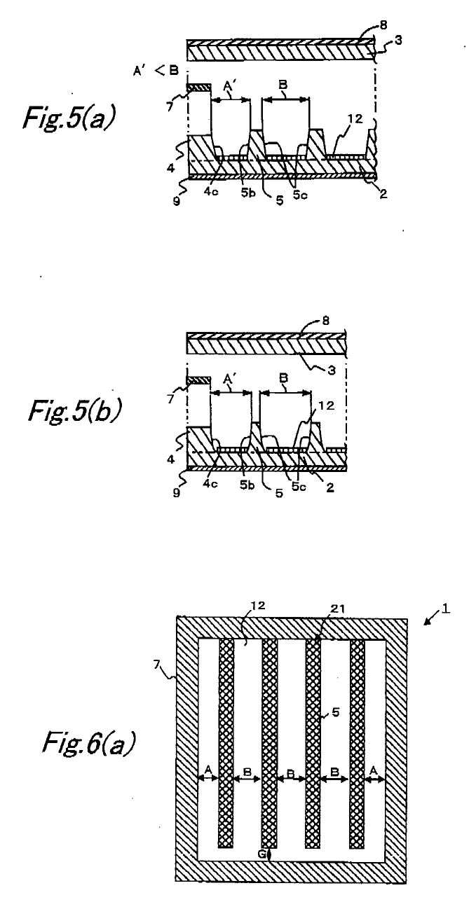

In the manufacture of the flat-type discharge lamp, it is preferable that as shown in FIGS. 5(a) and 5(b), the inner wall 4c of outer peripheral frame 4 and the side surface 5b of dielectric rib 5 opposed thereto and the side surfaces 5c of the other dielectric ribs 5 opposed to each other are tapered or curved downward to define the space A′ between the top of inner wall 4c and the top of side surface 5(b) smaller in width than the space B between the tops of side surfaces of the other dielectric ribs 5 opposed to each other. In this case, the first dielectric plate 2 can be machined by relatively coarse particles in the micro-blasting process. In such a practical embodiment, the height of outer peripheral frame 4 is determined lower than the dielectric ribs 5 in consideration with the thickness of glass adhesive coated thereon so that the outer peripheral edge of second dielectric plate 3 is bonded by the glass adhesive coated on the upper surface of outer peripheral frame 4 in a condition where the second dielectric plate 3 has been positioned by engagement with the tops of dielectric ribs 5.

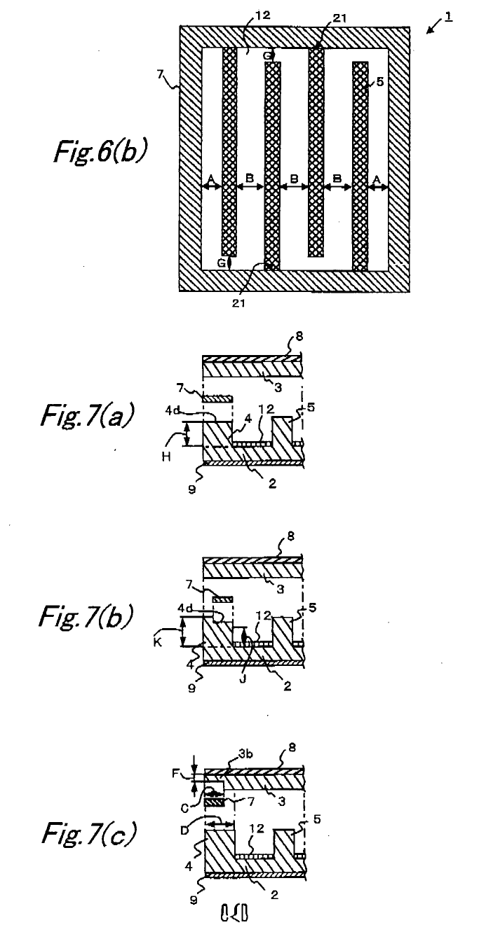

Illustrated in FIGS. 6(a) and 6(b) are other arrangements of the dielectric ribs 5 formed on the inner surface of first dielectric plate 2. As shown in FIG. 6(a), the dielectric ribs 5 may be spaced at their front ends from the inner wall surface of outer peripheral frame 4 and connected at their rear ends to the inner wall of outer peripheral frame 4 to form a plurality of sealed spaces in open communication. In this arrangement, it is desirable that a space G between the front ends of dielectric ribs 5 and the inner wall of outer peripheral frame 4 opposed thereto is determined narrower than a space A between the dielectric ribs 5 positioned at the left and right hands and the inner wall of outer peripheral frame 4. Alternatively, as shown in FIG. 6(b), the dielectric ribs 5 may be alternately spaced at their front ends from the inner wall of outer peripheral frame 4 and connected at their rear ends to the inner wall of outer peripheral frame 4 to form a plurality of sealed spaces in open communication. In such arrangement, it is desirable that each space G between the front or rear end of respective dielectric ribs 5 and the inner wall of outer peripheral frame 4 opposed thereto is determined narrower than a space A between the dielectric ribs 5 positioned at the left and right hands and the inner wall of outer peripheral frame 4.

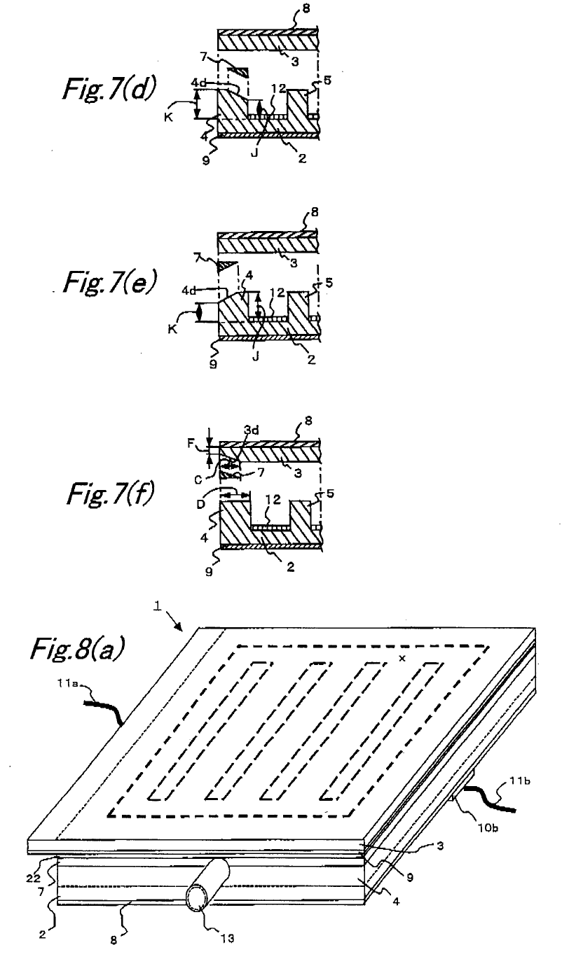

Illustrated in FIGS. 7 (a) and 7(b) is other connecting method of the first dielectric plate 2 to the second dielectric plate 3. As shown in FIG. 7(a), the height H of outer peripheral frame 4 may be determined lower than the dielectric ribs 5 in consideration with the thickness of glass adhesive 7 coated on the upper surface of outer peripheral frame 4 so that the second dielectric plate 3 is bonded at its bottom surface by means of glass adhesive coated on the entirety of the upper surface of outer peripheral frame 4. Alternatively, as shown in FIG. 7(b), the height K of the support surface of outer peripheral frame 4 may be determined at the same height as the dielectric ribs 5 so that the second dielectric plate 3 is bonded at its bottom surface by means of glass adhesive 7 coated in the recess 4d formed in the inside of outer peripheral frame 4. In such a case, as shown in FIG. 7(d), the recess 4d may be formed triangular in cross-section. In the case that the height of the support surface of outer peripheral frame 4 is determined at the same height as the dielectric ribs 5, as shown in FIG. 7(c), the second dielectric plate 3 may be formed at its outer peripheral portion with a recess 3d smaller in width than the support surface of outer peripheral frame 4 so that the second dielectric plate is bonded at its bottom surface by means of glass adhesive 7 coated in the recess 3d. In such a modification, the recess 3d may be formed triangular in cross-section as shown in FIG. 7(f). Furthermore, as shown in FIG. 7(e), the height of the support surface of outer peripheral frame 4 may be determined at the same height as the dielectric ribs 5 so that the second dielectric plate 3 is bonded at its bottom surface by means of glass adhesive 7 coated in a recess 4d of triangle in cross-section formed on the outer periphery of the support surface of frame 4.

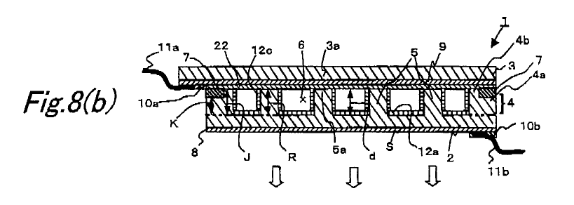

Illustrated in FIGS. 8(a) and 8(b) is another embodiment of the flat-type discharge lamp according to the present invention. In this embodiment, the transparent electrode 8 in the form of a thin membrane shown in FIG. 3(c) is disposed on the bottom surface of first dielectric plate 2 as a light emitting surface S, while the opaque electrode 9 in the form of a thin membrane is disposed on the inner surface of second dielectric plate 3. The opaque electrode 9 is supported on the dielectric ribs 5 through a dielectric membrane 22 and connected at one side thereof to the leading wire 11a by means of a conductive adhesive. On the other hand, the leading wire 11b is connected to one side of the transparent electrode by means of a conductive adhesive 10b.

1. A flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, and electrodes in the form of a thin membrane respectively deposited on the outer surfaces of the dielectric plates, wherein the electrodes are applied with a specified voltage to cause discharge in inert gas filled in spaces among the dielectric ribs within the sealed space thereby to produce visible light on a light emitting surface formed on at least one of the electrodes,
characterized in that the first dielectric plate is formed at its outer periphery with an outer peripheral frame having a support surface of the same height as the dielectric ribs, the second dielectric plate is bonded by an adhesive coated in a recess formed along one side of the support surface and secured tightly at its bottom surface in contact with the top surface of the respective dielectric ribs.

2. A flat-type discharge lamp as claimed in claim 1, wherein
a space between the inner wall surface of the outer peripheral frame and the dielectric rib opposed thereto is determined narrower in width than each space among the other dielectric ribs.

3. A flat-type discharge lamp as claimed in claim 1, wherein
the second dielectric plate is bonded in position by means of an adhesive coated in a recess formed along the outer periphery of the support surface of the outer peripheral frame in a condition where the bottom surface of the second dielectric plate has been positioned in contact with the support surface of the outer peripheral frame.

4. A flat-type discharge lamp as claimed in claim 1, wherein
the second dielectric plate is bonded in position by means of an adhesive coated in a recess formed along the inner periphery of the support surface of the outer peripheral frame in a condition where the bottom surface of the second dielectric plate has been positioned in contact with the support surface of the outer peripheral frame.

5. A flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, and electrodes in the form of a thin membrane respectively deposited on the outer surfaces of the dielectric plates, wherein the electrodes are applied with a specified voltage to cause discharge in inert gas filled in spaces among the dielectric ribs within the sealed space thereby to produce visible light on a light emitting surface formed on at least one of the electrodes,
characterized in that the first dielectric plate is formed at its outer periphery with an outer peripheral frame having a support surface of the same height as the dielectric ribs and that the second dielectric plate is retained tightly in contact with the dielectric ribs at its bottom surface and bonded to the upper surface of the outer peripheral frame by means of an adhesive coated in a recess formed along the outer periphery of its bottom surface in a condition where it has been positioned by engagement with the support surface of the outer peripheral frame.

6. A flat-type discharge lamp as claimed in claim 5, wherein a space between the inner wall surface of the outer peripheral frame and the dielectric rib opposed thereto is determined narrower in width than each space among the other dielectric ribs.

7. A flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, and electrodes in the form of a thin membrane respectively deposited on the outer surfaces of the dielectric plates, wherein the electrodes are applied with a specified voltage to cause discharge in inert gas filled in spaces among the dielectric ribs within the sealed space thereby to produce visible light on a light emitting surface formed on at least one of the electrodes,
characterized in that the first dielectric plate is formed at its outer periphery with an outer peripheral frame having a support surface lower in height than the dielectric ribs and that the second dielectric plate is bonded by means of an adhesive coated on the support surface of the outer peripheral frame in
a condition where the bottom surface of the second dielectric plate has been positioned by engagement with the top surfaces of the dielectric ribs.

8. A flat-type discharge lamp as claimed in claim 7, wherein
a space between the inner wall surface of the outer peripheral frame and the dielectric rib opposed thereto is determined narrower in width than each space among the other dielectric ribs.

9. A flat-type discharge lamp as claimed in claim 1,
wherein the dielectric ribs are integrally formed on the inner surface of the first dielectric plate and spaced in parallel with a predetermined distance, the dielectric ribs being spaced from the inner wall surface of the outer peripheral frame at their one ends in a longitudinal direction to form a plurality of sealed spaces in open communication to be filled with inert gas.

10. A flat-type discharge lamp as claimed in claim 9, wherein the dielectric ribs are tapered at their side surfaces opposed to each other toward the inner surface of the first dielectric plate.

11. A flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, an opaque electrode in the form of a thin membrane deposited on the outer surface of the first dielectric plate, a transparent electrode in the form of a thin membrane deposited on the inner surface of the second dielectric plate, wherein the electrodes are applied with a specified voltage to cause discharge in inert gas filled in spaces among the dielectric ribs within the sealed space thereby to produce visible light on a light emitting surface formed on the transparent electrode,
characterized in that the first dielectric plate is formed at its outer periphery with an outer peripheral frame having a support surface of the same height as the dielectric ribs and that the second dielectric plate is bonded by an adhesive coated in a recess formed along one side of the support surface and secured tightly at its bottom surface in contact with the top surface of the respective dielectric ribs.

12. A flat-type discharge lamp as claimed in claim 11, wherein a space between the inner wall surface of the outer peripheral frame and the dielectric rib opposed thereto is determined narrower in width than each space among the other dielectric ribs.

13. A flat-type discharge lamp composed of a first dielectric plate integrally formed at its inner surface with a plurality of spaced dielectric ribs at the same height defined by a specified discharge distance, a second dielectric plate assembled in parallel with the first dielectric plate to form a sealed space to be filled with inert gas, electrodes in the form of a thin membrane respectively deposited on the outer surface of the first dielectric plate and the inner surface of the second dielectric plate, wherein the electrodes are applied with a specified voltage to cause discharge in inert gas filled in spaces among the dielectric ribs within the sealed space thereby to produce visible light on a light emitting surface formed on the electrode deposited on the outer surface of the first dielectric plate or the electrode deposited on the inner surface of the second dielectric plate,
characterized in that the electrode in the form of the membrane deposited on the inner surface of the second dielectric plate is provided at its inner surface with a fluorescent thin membrane and that the first dielectric plate is formed at its outer periphery with an outer peripheral frame having a support surface of the same height as the dielectric ribs, the second dielectric plate being bonded by an adhesive coated in a recess formed along one side of the support surface and secured tightly at its bottom surface in contact with the top surface of the respective dielectric ribs.

14. A flat-type discharge lamp as claimed in claim 13, wherein a space between the inner wall surface of the outer peripheral frame and the dielectric rib opposed thereto is determined narrower in width than each space among the other dielectric ribs.

15. A flat-type discharge lamp as claimed in claim 2, wherein
the second dielectric plate is bonded in position by means of an adhesive coated in a recess formed along the outer periphery of the support surface of the outer peripheral frame in a condition where the bottom surface of the second dielectric plate has been positioned in contact with the support surface of the outer peripheral frame.

16. A flat-type discharge lamp as claimed in claim 2], wherein
the second dielectric plate is bonded in position by means of an adhesive coated in a recess formed along the inner periphery of the support surface of the outer peripheral frame in a condition where the bottom surface of the second dielectric plate has been positioned in contact with the support surface of the outer peripheral frame.

17. A flat-type discharge lamp as claimed in claim 5,
wherein the dielectric ribs are integrally formed on the inner surface of the first dielectric plate and spaced in parallel with a predetermined distance, the dielectric ribs being spaced from the inner wall surface of the outer peripheral frame at their one ends in a longitudinal direction to form a plurality of sealed spaces in open communication to be filled with inert gas.

18. A flat-type discharge lamp as claimed in claim 7,
wherein the dielectric ribs are integrally formed on the inner surface of the first dielectric plate and spaced in parallel with a predetermined distance, the dielectric ribs being spaced from the inner wall surface of the outer peripheral frame at their one ends in a longitudinal direction to form a plurality of sealed spaces in open communication to be filled with inert gas.
